(19) United States
(12) Patent Application Publication
(10) Pub. No.: US 2007/0223889 A1
(43) Pub. Date: Sep. 27, 2007

(54) Embedded high definition media management module for information handling systems

(76) Inventors: Shree A. Dandekar, Round Rock, TX (US); Jeremy Friedlander, Austin, TX (US)

Correspondence Address: HAMILTON & TERRILE, LLP, P.O. BOX 203518, AUSTIN, TX, 78720, US

(21) Appl. No.: 11/377,060

(22) Filed: Mar. 16, 2006

(51) Int. Cl. H04N 5/00

(52) U.S. Cl. 386/125

(57) ABSTRACT

A method for navigating within a disc. The method includes authoring the disc, the authoring including storing a plurality of files on the disc and a media management module on the disc and using a media management generation module to associate the files with search criteria, and executing the media management module when the disc is inserted into an information handling system, the executing presenting a user with an option of searching files stored on the disc using with the search criteria is disclosed.

### BACKGROUND OF THE INVENTION

1. Field of the Invention

The present invention relates to information handling systems and more particularly to embedded high definition media management modules for information handling systems

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A known use of information handling system is the storage and presentation of high definition information stored in optical devices. High definition information may be displayed at up to 1080 lines of resolution, compared to 480 lines for traditional televisions. To store the data necessary to present high definition, high capacity re-writable optical discs have been proposed. One such high capacity re-writable disc is a Blu-ray optical disc. A Blu-ray optical disc can store two hours of high definition video or up to 12 hours of standard video. A single sided single layer Blu-ray disc can store approximately 23.3, 25 or 27 GB of data compared to the approximately 4.7 GB of data stored on a standard DVD. A dual layer disc can store approximately, 46.6 GB, 50 GB or 54 GB of data.

There are a number of formats which conform to the Blu-ray disc standard. For example, a Blu-ray disk, write once (BD-R) format is a recordable format for HDTV recording and for PC data storage and a Blu-ray disk rewriteable (BD-RE) format is a rewritable format for HDTV recording and PC data storage. A Blu-ray disc application (BDAV) format is a generalized format for digital recording.

A typical use case scenario for Blu-ray BD-RE or BDAV disc entails a customer burning a collection of data or video content onto a single disk. With 50 GB of content, there could be 30,000+ of files on a single disk. Some of this content may be viewable/playable on a television via a set-top box and some is not.

An issue arises when a user attempts to scroll through upwards of 25 or 50 GB of content. It may be difficult for the user to locate the exact video file that the user wishes to play via the set-top box. With such a large quantity of data, consumers may have a difficult time locating specific files or content much like it is difficult to find a specific file or email on an information handling system hard drive.

Known authoring software provides the ability to display all the content that a standard DVD (4.7 GB or Dual Layer 9.0 GB). However, this authoring software has limitations in handling and displaying large amount of content. For example, this authoring software may not provide an ability for customers to search and organize content on the disc while viewing the content via their set-top boxes. Also for example, known authoring software solutions do not provide a mechanism to assist consumers from seeing, sorting, searching and, selecting only what is playable and hiding what isn't playable.

### SUMMARY OF THE INVENTION

In accordance with the present invention, a media management module is set forth which is embedded into a high definition optical disc when a customer authors a video project which assists in the navigation and searching content stored within the optical disc. In one embodiment, the optical disc conforms to a BD-RE physical layer and BDAV logical layer standard and supports creation of BD-RE or BDAV media on an information handling system which may then be loaded and played by a Blu-ray disc (BD) consumer device. Thus, a consumer is presented with all the content that can be accessed by that device, and can search on that content. The media management module is operating system independent. In certain embodiments, the media management module may be stored on the information handling device rather than the disc, in which case the search functions loaded onto the disc would only operate with information handling systems having the media management module.

More specifically, in one embodiment, the invention relates to a method for navigating within a disc. The method includes authoring the disc, the authoring includes storing a plurality of files on the disc and a media management module on the disc, the authoring includes using a media management generation module to associate the files with search criteria, and executing the media management module when the disc is inserted into an information handling system, the executing presenting a user with an option of searching files stored on the disc using with the search criteria.

In another embodiment, the invention relates to an apparatus for navigating within a disc. The apparatus includes means for authoring the disc and means for executing the media management module when the disc is inserted into an information handling system. The authoring includes storing a plurality of files on the disc and a media management module on the disc. The authoring also includes using a media management generation module to associate the files with search criteria. The executing presents a user with an option of searching files stored on the disc using with the search criteria.

In another embodiment, the invention relates to an information handling system which includes a processor and memory coupled to the processor. The memory stores a media management generation module which enables authoring a disc. The authoring includes storing a plurality of files on the disc and a media management module on the disc. The authoring also includes associating the files with search criteria. The media management module executes when the disc is inserted into an information handling system. The executing presents a user with an option of searching files stored on the disc using with the search criteria.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a system block diagram of an information handling system.

FIG. 2 shows a block diagram of a high definition media device which includes a media management module.

FIG. 3 shows an example screen presentation of disc library function of the media management module.

FIG. 4 shows a series of example screen presentations for a scene search of the media management module.

FIG. 5 shows a system block diagram of an alternate information handling system.

### DETAILED DESCRIPTION

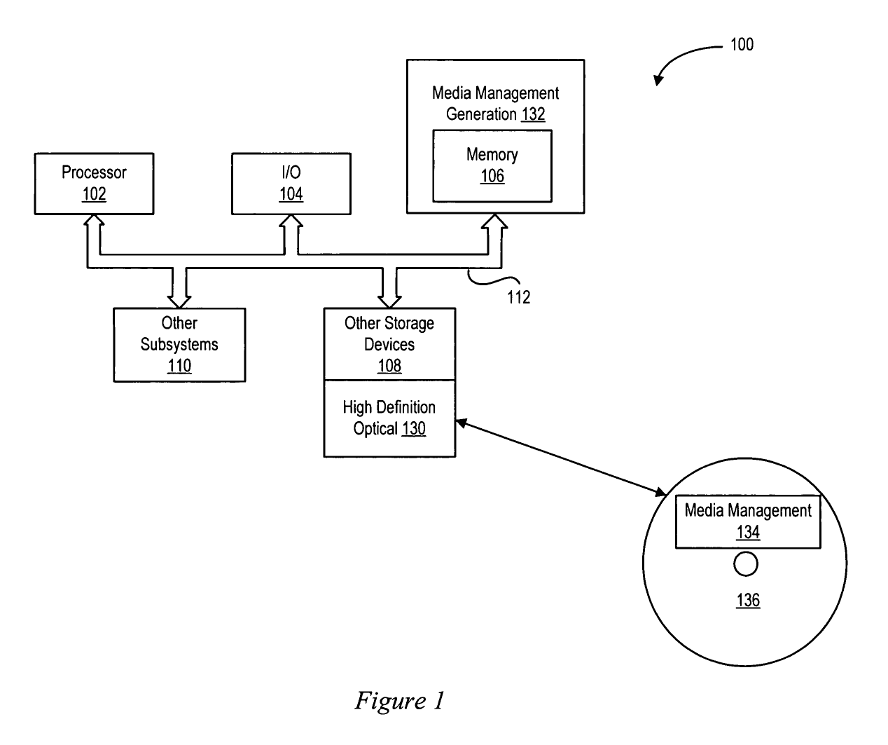

Referring briefly to FIG. 1, a system block diagram of an information handling system 100 is shown. The information handling system 100 includes a processor 102, input/output (I/O) devices 104, such as a display, a keyboard, a mouse, and associated controllers, memory 106 (which can include volatile memory such as random access memory and non-volatile memory such as a hard disk drive), and other storage devices 108, such as CD ROM or DVD disk drive, and various other subsystems 110, all interconnected via one or more buses 112. The other storage devices 108 includes an optical device 130 which conforms to a high definition storage standard such as the Blu-ray optical storage standard. The other storage devices 108 also includes a media management generation module 132 which enables generating and storing a media management module 134 onto an optical disc 136.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components. Also for example, an information handling system may be a device which is configured to read and provide for presentation information from high definition media such as Blu-ray media and more specifically BD-RE and BDAV specific media.

The media management module 134 is embedded into a high definition optical disc by the media management generation module 132 when a customer authors a video project.

The media management module 134 assists in the navigation and searching of content stored within the optical disc. The optical disc may conforms to a BD-RE physical layer and BDAV logical layer standard and supports creation of BD-RE or BDAV media on an information handling system 100 which may then be loaded and played by a BD consumer device. Thus, a consumer is presented with all the content that can be accessed by that device, and can search on that content. The media management module is operating system independent.

Thus, the media management module 134 provides a smart media content management agent that is embedded in the Blu-ray BD-RE or BDAV disc when a customer authors a video project or burns any other data onto the disc 135. The smart media content agent can function on BD consumer devices (or other types of consumer electronics (CE)) as well as on any information handling system environment that supports the high definition media type. The size of the media management module 134 is negligible when compared to the actual storage available within the high definition media.

The media management module 134 is compatible with many set-top players available in the market. To be compatible with the media management module, the set-top players (or other consumer devices) may be required to perform a firmware update to be able to set a flag that reads the utility off of the BD media. The media management module 134 is activated when a disc 136 is inserted into a set-top box (or other consume device). The media management module 134 provides menu driven interface to the customer. By using different options within the media management module, a customer is able to browse through the contents of a disc 136, search for a particular file on the disc 136, sort the content of the disc, select a particular file stored on the disc 136 for playback, and operate a smart filter on a per device basis (e.g., the disc operation on a computer system might be set to be different from the operation on a set top box). The media management module 134 does not require any operating system (OS) specific components to be installed on the presentation device. When a customer creates a media project (such as an open dvd project) and continues to added content to the previously authored disc, the media management module 134 dynamically refreshes a content list for the media project.

Additionally, a media management generation module 132 and a media management module 136 provide an information handing system supplier with an upselling ability as the desirability of more advanced authoring software becomes apparent when using the media management generation module 132.

The media management module 136 may also be installed onto non-high definition disc formats such as known CD/DVD media formats.

By using the media management generation module 132 and the media management module 136, a customer is able to transport a high definition disc such as a Blu-ray disc and play the disc on other high definition devices such as a Media Extender device, Media Center personal computer, a set-top box or a standard personal computer.

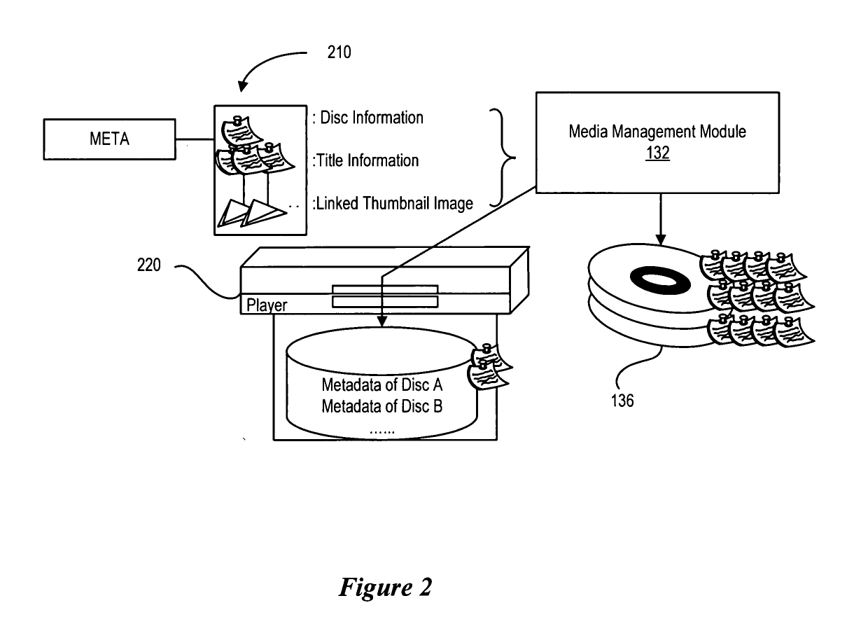

FIG. 2 shows a block diagram of a high definition media device which includes a media management module 134. More specifically, when a disc 136 is authored or updated, the media management generation module 134 creates a meta data file 210 that operates with the media management module 134 to enable a user to navigate the content that is stored on the disc 136. The navigation includes browsing, searching, sorting and selecting of one or more files that are stored on the disc 136. The meta data that is stored on the disc and associated with respective files can include disc information, title information, as well as a thumbnail image that is linked to the file. The meta data can also include searchable information that can be inserted either when the disc is authored or when the disc is updated. When the disc 136 is loaded into a high definition player 220, the media management module 132 executes to enable the user to navigate the content that is stored of the disc 136.

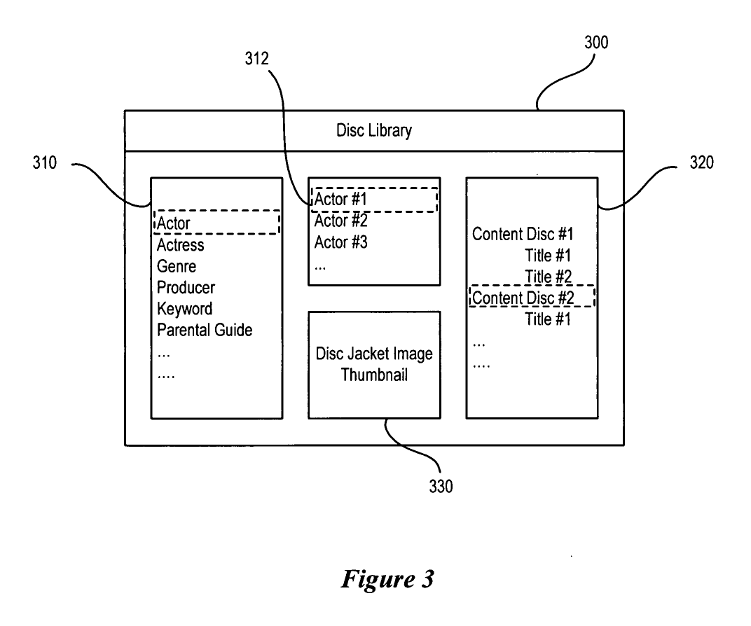

FIG. 3 shows an example screen presentation 300 of disc library function of the media management module 134. More specifically, the disc library function presents a user with content information about one or more discs 136. The content information includes descriptor information 310 (e.g., Actor, Actress, Genre, Producer, Keyword or Parental Guide), sub-descriptor information 312 for a particular descriptor (e.g., Actor 1, Actor 2, Actor 3). The content information also includes search results 320 relevant to a particular search (e.g., the disc and titles that correspond to a particular search). The content information also includes a thumbnail image such as a disc jacket thumbnail image for the particular disc.

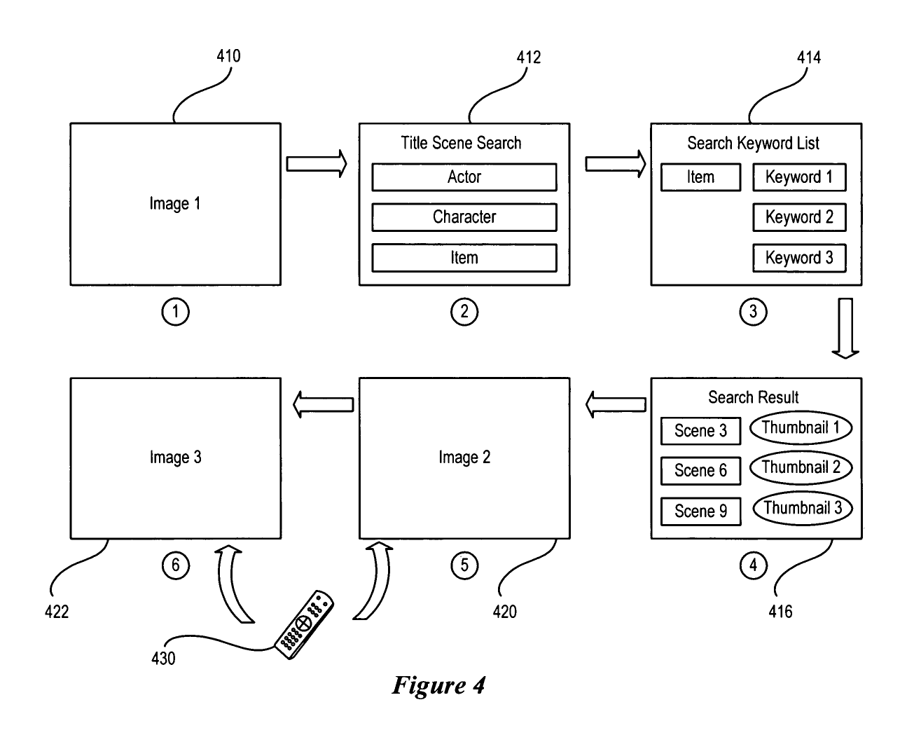

FIG. 4 shows a series of example screen presentations for a scene search of the media management module. More specifically, when the an image 410 (image 1) is being presented on a display device of an information handling system, a content search may be initiated by a user. When the content search is initiated, a search screen presentation 412 is presented on the display device. The content search may search on a number of criteria such as an actor, a character or an item. When the user selects a particular search criteria, then a detailed criteria screen presentation 414 is presented. The detailed screen presentation presents a number of keywords (e.g., keyword 1, keyword 2, keyword 3) that are relevant to the search criteria. The keywords may be generated via when media management generation module 132 when the disc is authored, or may be generic keywords that are present within the media management module 134. A search result screen presentation 416 is then presented on the display device. The search result screen presentation 416 includes an identifier for each located scene (e.g., scene 3, scene 6, scene 9) as well as a thumbnail corresponding to each of the located scenes (e.g., thumbnail 1, thumbnail 2, thumbnail 3).

The user may then navigate to one of the located scenes which is presented as an image 420 (image 2) on the display device. The user may also navigate to another one of the located scenes which is presented as an image 422 (image 3) on the display device. The user may perform each of these navigation functions via a remote control device 430 (which is an example of an I/O device 104).

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Also, for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

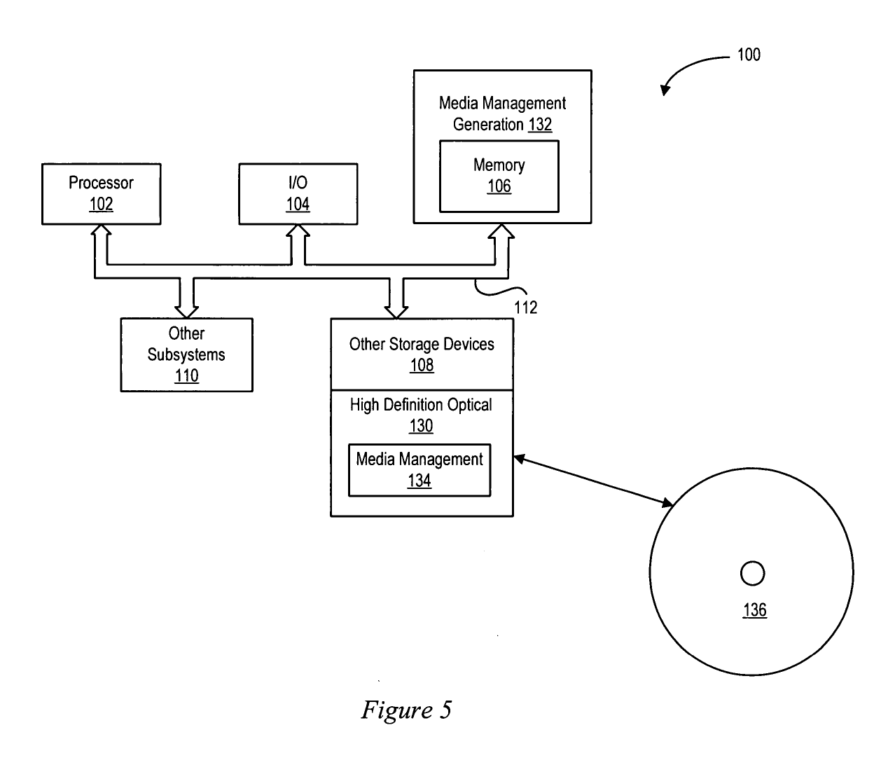

Also for example, referring to FIG. 5, the media management module may be stored on the information handling system, rather than the disc. In this case, only information handling systems having the media management module would be able to search on the information associated within the authored disc.

Consequently, the invention is intended to be limited only by the spirit and scope of the appended claims, giving full cognizance to equivalents in all respects.

What is claimed is:

1. A method for navigating within a disc comprising:
authoring the disc, the authoring including storing a plurality of files on the disc and a media management module on the disc, the authoring including using a media management generation module to associate the files with search criteria;
executing the media management module when the disc is inserted into an information handling system, the executing presenting a user with an option of searching files stored on the disc using with the search criteria.

2. The method of claim 1 wherein:
the disc is a high definition optical disc.

3. The method of claim 2 wherein:
the high definition optical disc corresponds to a Blu-ray standard.

4. The method of claim 1 wherein:
the search criteria include an actor, a character and an item.

5. The method of claim 1 wherein:
the authoring includes linking a thumbnail image with each of the files.

6. The method of claim 1 further comprising:
updating the disc when new files are stored on the disc, the updating including using the media management generation module to associate the new files with search criteria.

7. The method of claim 1 wherein:
the media management module is operating system independent.

8. An apparatus for navigating within a disc comprising:
means for authoring the disc, the authoring including storing a plurality of files on the disc and a media management module on the disc, the authoring including using a media management generation module to associate the files with search criteria;
means for executing the media management module when the disc is inserted into an information handling system, the executing presenting a user with an option of searching files stored on the disc using with the search criteria.

9. The apparatus of claim 8 wherein:
the disc is a high definition optical disc.

10. The apparatus of claim 9 wherein:
the high definition optical disc corresponds to a Blu-ray standard.

11. The apparatus of claim 8 wherein:
the search criteria include an actor, a character and an item.

12. The apparatus of claim 8 wherein:
the authoring includes linking a thumbnail image with each of the files.

13. The apparatus of claim 8 further comprising:
means for updating the disc when new files are stored on the disc, the updating including using the media management generation module to associate the new files with search criteria.

14. The apparatus of claim 8 wherein:
the media management module is operating system independent.

15. An information handling system comprising:
a processor;
memory coupled to the processor, the memory storing
a media management generation module, the media management generation module enabling authoring a disc, the authoring including storing a plurality of files on the disc and a media management module on the disc, the authoring including associating the files with search criteria, the media management module executing when the disc is inserted into an information handling system, the executing presenting a user with an option of searching files stored on the disc using with the search criteria.

16. The information handling system of claim 15 wherein:
the disc is a high definition optical disc.

17. The information handling system of claim 16 wherein:
the high definition optical disc corresponds to a Blu-ray standard.

18. The information handling system of claim 15 wherein:
the search criteria include an actor, a character and an item.

19. The information handling system of claim 15 wherein:
the authoring includes linking a thumbnail image with each of the files.

20. The information handling system of claim 15 wherein:
the media management generation module updates the disc when new files are stored on the disc, the updating including associating the new files with search criteria.

21. The information handling system of claim 15 wherein:
the media management module is operating system independent.

22. A method for navigating within a disc executing on an information handling system having a media management module, the method comprising:
authoring the disc, the authoring including storing a plurality of files on the disc, the authoring including using a media management generation module to associate the files with search criteria;
executing the media management module when the disc is inserted into an information handling system, the executing presenting a user with an option of searching files stored on the disc using with the search criteria.
